(19) United States
(12) Patent Application Publication
(10) Pub. No.: US 2003/0053792 A1
(43) Pub. Date: Mar. 20, 2003

(54) Management of digital memory during playback of moving images

(75) Inventor: Angel Janevski, New York, NY (US)

Correspondence Address: Corporate Patent Counsel, Philips Electronics North America Corporation, 580 White Plains Road, Tarrytown, NY, 10591, US

(73) Assignee: Koninklijke Philips Electronics N.V.

(21) Appl. No.: 09/956,704

(22) Filed: Sep. 20, 2001

(51) Int. Cl. H04N 5/76; G11B 15/52; G11B 5/09; G11B 19/02; G11B 20/10

(52) U.S. Cl. 386/46; 369/47.1

(57) ABSTRACT

Management of digital storage space during the playback of moving images in a broadcasted program or any other coherent moving image presentation involves marking already-viewed frames for deletion. The marking occurs before completion of the playback of the presentation so that memory space is made immediately available for additional recording of other broadcasted presentations or for other purposes before completion of the playback of the video. A latency time period between playback and authorization for deletion gives the viewer flexibility to replay parts of the presentation before deletion. The latency time period is optionally adaptable, and may be adjusted in accordance with automatic monitoring of whether the viewer is viewing the playback and in accordance with predefined parameters derived from the stored presentation. A count may be maintained of the number of times a frame is played back to refrain from marking until a particular count is reached.

### BACKGROUND OF THE INVENTION

1. Field of the Invention

The present invention relates generally to the management of digital memory, and more particularly to maintenance of a digital memory during playback of a video recorded therein.

2. Description of the Related Art

Recently, there has been a substantial increase among subscribers to video services (e.g., cable, satellite) in the amount of automatic recording of moving picture sequences for playback at the discretion of the subscriber. Digital devices such as personal video recorders (PVRs) may be used to record broadcasted television and cable programs, as well as other image-based content. Personal video recorders may be programmed to automatically find and record a user's favorite television program or programs so that the user may watch what he or she wants, when he or she wants. Currently, personal video recorders contain a substantial amount of memory and are capable of recording more than thirty hours of programming. The recorded programming may then be retrieved and viewed by the user as desired.

The amount of memory may nevertheless fall short of what the viewer needs, because, for example, PVRs can be programmed to record all broadcasts of a particular type (e.g., all football games). A viewer may navigate a menu sequence after viewing the program to delete the program, and thereby make more memory available for recording. Alternatively, the system can be set to time tag programs that have been watched, and to periodically delete these programs based an expiration time. In either case, however, the memory is not being used to its full potential, because memory that is no longer needed is not immediately freed and made available to record live broadcasts and to take advantage of other recording opportunities.

A second area of concern is that broadcasted programs, sporting events and movies, once recorded locally as by the viewer's home PVR, are available to the viewer to be repeatedly watched as many times as desired. Local establishments, such as bars and restaurants, can also record the broadcast and replay it any number of times for their customers. In these cases, the service provider may have no practical way to monitor the number of times the presentation has been viewed in order to bill the subscriber an amount reflective of the number of viewings, or, alternatively, has no way to limit that number.

### SUMMARY OF THE INVENTION

The present invention addresses the deficiencies and shortcomings of the prior art noted above and is directed to an apparatus and method for managing digital memory space occupied by a video frame. The video frame includes a marking device for marking the memory space as being available as memory space that can be overwritten or reused. The availability becomes effective after the video frame has played on a video player. A video as discussed herein is defined as any series of image frames that collectively encompass and constitute a prepared presentation, such as a movie, sporting event, play, documentary film, or broadcasted television or cable program, with or without audio. A video frame is part of a video the constitutes a frame or snapshot. A video player is any apparatus or unit for playing a video.

In another aspect, this invention is directed to marking the memory space as available as memory space that can be overwritten or reused, the availability becoming effective at a predetermined latency time after the playing of the frame.

In a still further aspect, this invention is directed to marking the memory space as available, the memory space being part of a digital memory, the video frame being part of a video occupying the digital memory, and the availability of the frame becoming effective during playback of the video. Therefore, memory is freed and made available to record live broadcasts and to take advantage of other recording opportunities while the video is being viewed.

In another aspect, this invention is directed to marking memory space for availability as memory space that can be overwritten, and writing into the memory space after a video frame in a memory space has been played, to make the video frame substantially unrecoverable. Accordingly, a service provider may limit or monitor the number of showings of the video to a private viewer or by third parties in a commercial setting.

In yet another aspect, this invention is directed to playing a video frame that resides in an area of digital memory, and marking the frame to be deleted after it plays.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 illustrates a first embodiment of a video playback system in accordance with the present invention;

FIG. 2 illustrates a personal video recorder (PVR) in accordance with the present invention;

FIG. 3 shows a digital memory in accordance with the present invention;

FIGS. 4A and 4B illustrate respective concurrent processes in accordance with the present invention;

FIG. 5 illustrates a second embodiment of a video playback system in accordance with the present invention;

FIG. 6 shows a digital memory for use in a third embodiment of the invention;

FIG. 7 shows a digital memory for use in a fourth embodiment of the invention; and

FIG. 8 shows a hypothetical Group of Pictures (GOP) for use with the present invention.

### DETAILED DESCRIPTION OF THE PRESENTLY PREFERRED EMBODIMENTS

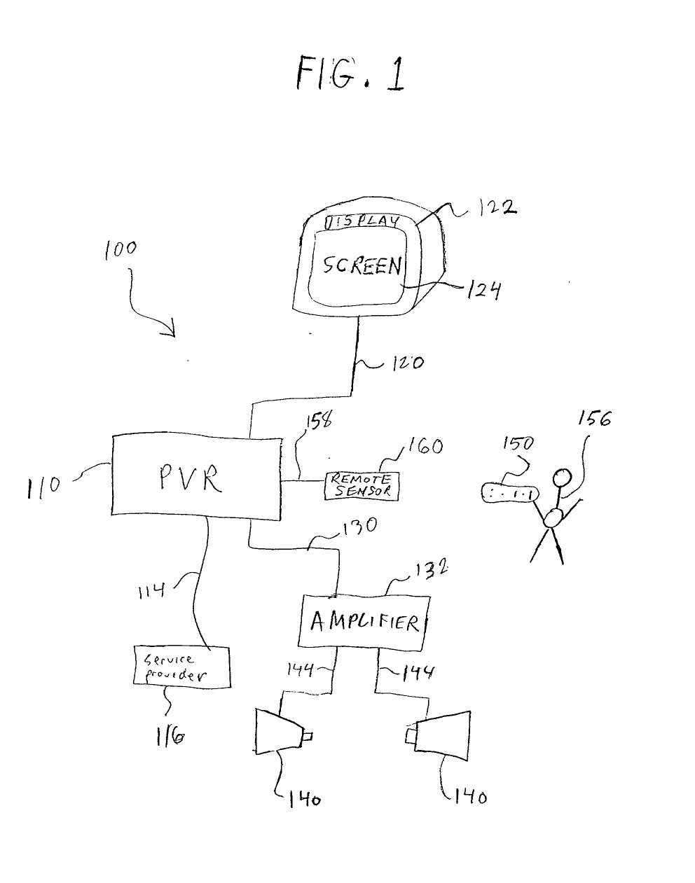

Referring now in specific detail to the drawings in which like reference numerals identify similar or identical elements throughout the several views, and initially to FIG. 1, a first embodiment of an exemplary video playback system 100, as illustrated in FIG. 1, includes a PVR 110 connected by a cable 114 to a service provider 116 which provides video input. The PVR 110 is also connected via a data and control bus 120 to a display 122 having a viewing screen 124. The PVR 110 is further connected via a data and control bus 130 to an amplifier 132 that communicates to speakers 140 over speaker wires 144. A remote control 150 allows a user or viewer 156 to remotely operate the system 100. A bus 158 connects the PVR 110 to a remote sensor 160.

In typical operation, the viewer 156 operates the remote control 150 to turn on or activate the playback system 100. The remote control 150 typically sends an activation signal, by infrared or other means, which is received by the remote sensor 160. In response to the activation signal, the PVR 110 plays a video which the service provider 116 has provided over the bus 114. Playback sends images over the bus 120 to the display 122 to be shown on the screen 124. Playback also sends audio over the bus 130 to the amplifier 132 to be amplified and transmitted over the speaker wires 144 to the speakers 140 which transmit the sound to the user 156.

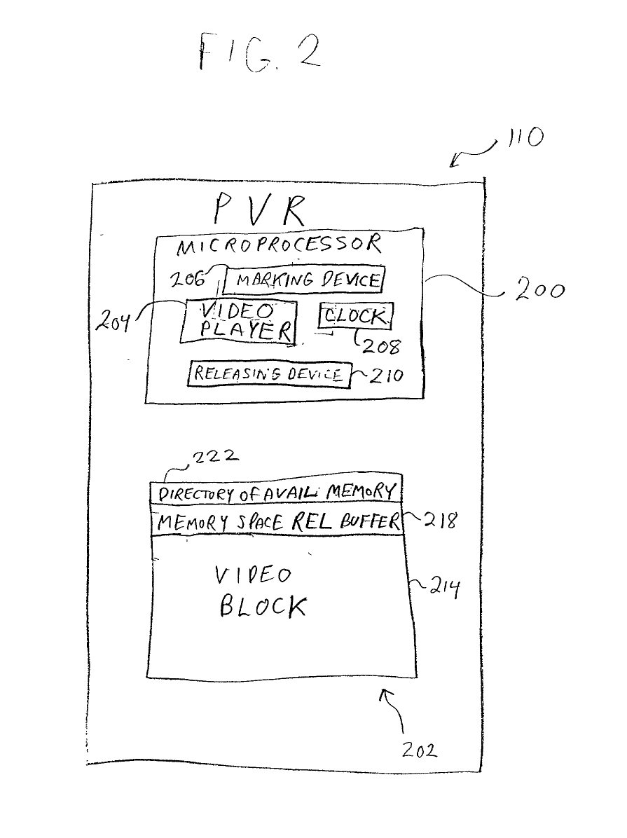

In FIG. 2, the exemplary PVR 110 contains a microprocessor 200, a digital memory 202, and an input/output processor (not shown) for communication with the other system components illustrated in FIG. 1, such as the service provider 116, display 122, amplifier 132, remote control 150, and remote sensor 160 through standard ports and other input/output means. Incorporated into the microprocessor 200 is a video player 204, a marking device 206, a clock 208 and a releasing device 210. The digital memory 202 includes a video block 214, a memory space release buffer 218 and a directory of available memory 222.

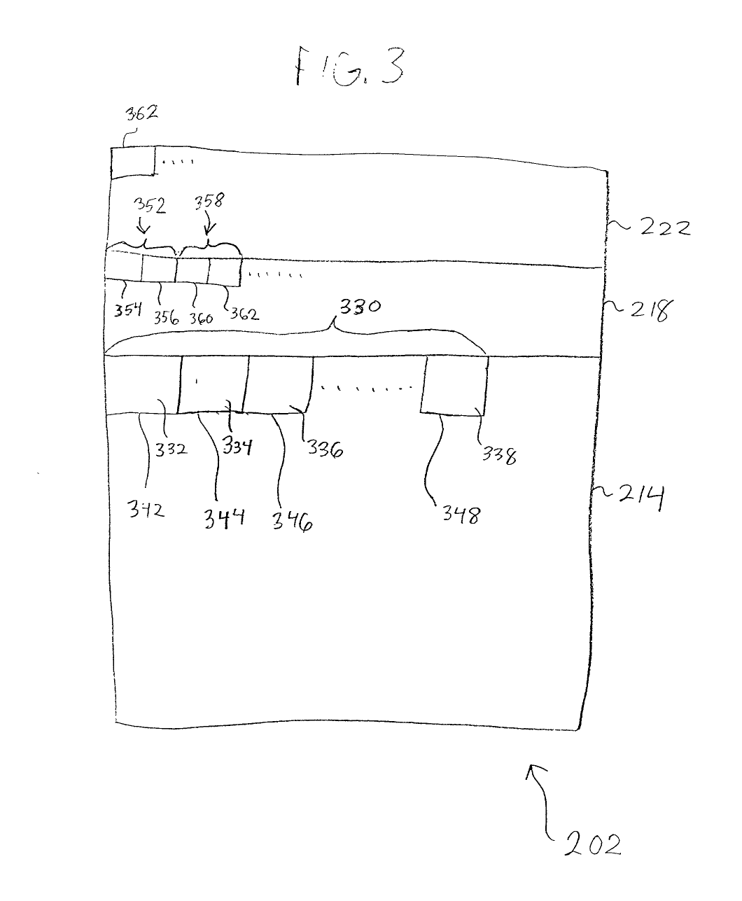

The video block 214 is preferably of the read-while-write (RWW) type, so that a portion of the block 214 can be written to or erased while another portion is simultaneously read. The video block 214, as shown in more detail in FIG. 3, contains videos consisting of video frames. For illustration, video frames 332, 334, 336 and 338 of a video 330 are shown in respective memory spaces 342, 344, 346 and 348. The video 330 contains frames intervening as shown by the dots. Other videos may also exist in the video block 214.

The memory space release buffer 218 has a plurality of entries that each consist of an identifier of or pointer to an area of memory and a time stamp associated with playback of the content of that area. In the current example, the entry 352 in the buffer 318 has an identifier 354 of the area 342 and a time stamp 356. Similarly, an entry 358 consists of an identifier 360 and a time stamp 362. As shown by the dots, other entries may exist for corresponding areas of the video block.

The directory of available memory 222 contains entries with pointers to areas of memory available in the video block 214. An entry 362 is shown, with following dots to represent other entries.

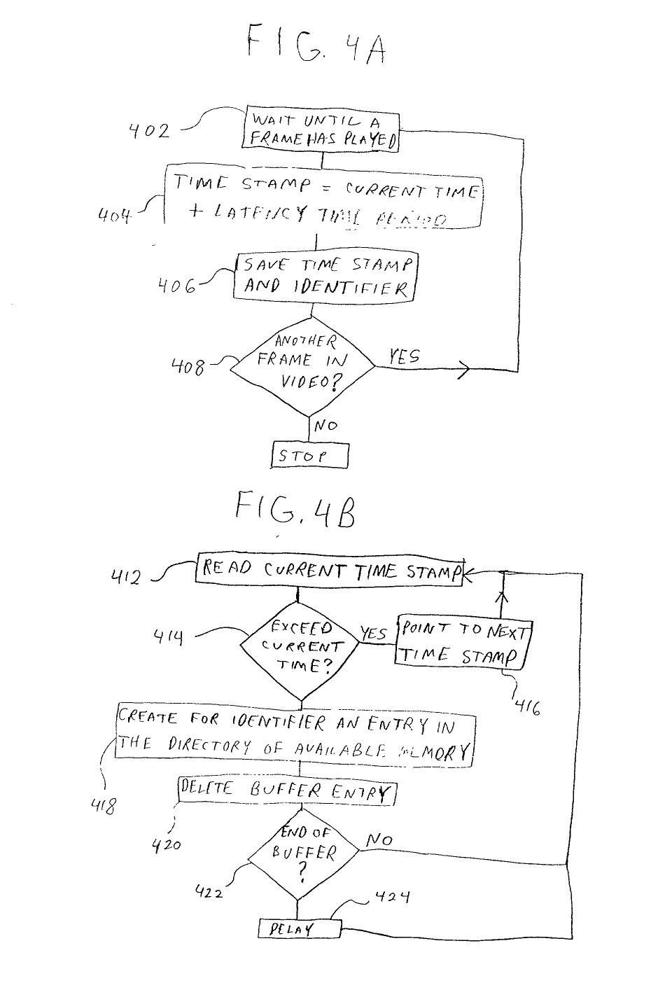

FIG. 4A is a flow diagram that illustrates the process of marking frames for availability in accordance with the invention. In step 402, and referring to FIGS. 2 and 3, the frame 334 has just completed playing on the PVR 110. In step 404, the marking device 206 reads the clock 208 to obtain the current time, determines a “latency time period” and adds the period to the current time. The latency time period gives the user a chance to take a break, or partially “rewind” the video to replay a portion, before the already-viewed frames are available for deletion. The resulting sum of the current time and the latency time period is the time stamp 362 shown in FIG. 3. The identifier 360 in the entry 358 points to the memory address of the frame 334. The marking device 206 marks the frame 334 for availability by saving the identifier 360 and the time stamp 362 to the buffer 218 in step 406. In step 408, if another frame in the video exists, the process repeats; otherwise, the process terminates.

FIG. 4B is a flow diagram that illustrates the process of making effective the availability of a memory space for overwriting or reuse in accordance with the invention. In step 412, the releasing device 210 reads a current one of the time stamps, for example, the time stamp 356 from the buffer 218. The releasing device 210 also reads the current time from the clock 208. If in step 414 the time stamp exceeds the current time, the releasing device 210 updates a time stamp pointer in step 416 to the next time stamp in the buffer 218, which in this example is the time stamp 362. Otherwise, in step 418, the releasing device 210 creates for the identifier, here the identifier 354, an entry, such as the entry 362, in the directory of available memory 222. Since, as mentioned above, the identifier 354 points to the memory space 342, the entry 362 which has been copied from the identifier 354 now points the memory space 342. By creating the entry 362 in the directory of available memory 222, the releasing device 210 has made effective the availability of the marked memory space 342 for overwriting or reuse. For example, the memory space 342 is now available for reallocation by the microprocessor 200 to any frame needing memory space in the video block 214. Further, and as discussed in more detail below, the memory space 342 is now available for manipulation that makes the video frame 332 substantially unrecoverable to a potential reader of the video frame. Step 420 deletes the buffer entry 352, which has served its purpose of providing a latency time period between playing a frame and making the memory space that the frame occupies available as memory space that can be overwritten or reused. Step 422 queries if the latest entry of the buffer 218 has been processed. If not, the process of making memory availability effective is repeated. If the last entry has been processed, a delay is introduced in step 424 before repeating the process.

The process shown in FIG. 4A writes to the buffer 218 in step 406 and the process shown in FIG. 4B reads from the same buffer 218 in step 412, the two processes running concurrently. In the current embodiment, contention between reads and writes is avoided by implementing the buffer 218 as RWW memory. Alternatively, if the buffer 218 can only be written to or read at any given moment, a read/write controller can resolve access between simultaneous reading and writing requests.

As mentioned, the length of the predetermined latency time period is tailored to afford the viewer 156 of the video 330 being played back a convenient break time in which, for example, the viewer can leave the viewing area briefly, or attend to other activities, and return to “rewind” and replay the missed portion of the playback. For example, 5-10 minutes would give a viewer enough time to take a break, pick up the phone, and rewind to catch up. On the other hand, in serving an overall purpose of the invention of releasing memory during playback so that recording opportunities are not missed, the latency time period is generally made short enough so that ordinarily the memory space for a frame is released during playback of the video that contains the frame. Thus, as a video plays back, the availability for reuse or overwriting of the memory space for frames played back is made effective prior to the completion of playback of the video.

As the video player 204 plays the video 330, the memory spaces occupied by the frames of the video as they are played are marked for future availability, the availability becoming effective at a predetermined latency time period after the playing of the frame. Moreover, for at least some of the memory spaces occupied by respective frames, the availability preferably becomes effective while the video is playing. Also as the video 330 plays, the releasing device 210 updates the directory of available memory 222 to include entries pointing to memory spaces in the video block 214 whose availability has, due to an expired latency time period, become effective, and, therefore have been released. Incoming broadcasted videos or other videos of interest can be stored in the video block 214 to occupy the released digital memory. If the viewer 156 wants to take a break from viewing, the viewer 156 can operate the remote control 150 to put the playback system 100 in pause mode. An advantage of using pause mode is that the clock 208 is also paused, thereby stopping expiry of the latency time period. If the viewer 156 forgets to pause the system 100, memory space for frames that have been marked continues, as their respective latency time period expires, to be made immediately available as memory space that can be overwritten or reused.

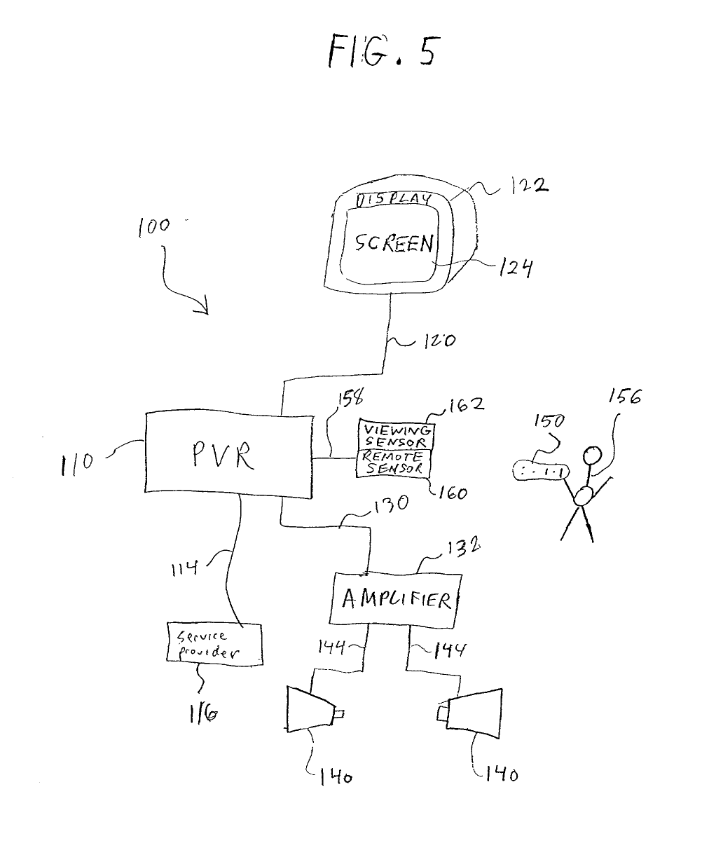

The predetermined latency time period may be adaptive, and, in a second embodiment of the invention, this adaptability tends to preserve a viewer's opportunity to replay recent portions of the video 330 after a break in which the viewer failed to pause the system 100. This second embodiment, shown in FIG. 5, is essentially the same as that shown in FIG. 1, except for the addition of a viewing sensor 162. The viewer 156 who is watching the video 330 playing on the screen 124 of the display 122 is being observed by the viewing sensor 162. The microprocessor 200 determines, based on output of sensor 162, if the viewer 156 is watching the screen 124. If not, the latency time period is enlarged in expectation that the viewer will want to replay a missed portion of the video 330 before that missed portion is deleted and that extra latency time may be needed for the replay. Alternatively, marking is halted altogether while it is detected that the viewer 156 is not watching the screen 124. These checks can be performed periodically, for example, in which case the latency time period may be restored if and when the viewer 156 resumes watching.

In one implementation, the PVR 110 or other part of the apparatus transmits a sound or light beam. It is determined from the reflection received by the viewing sensor 162 whether the viewer is present. A more sophisticated method uses the viewing sensor 162, by means well known in the art, to recognize facial features of the viewer and their orientation to decide whether the viewer's eyes are on the screen 124.

The latency time period, whether fixed or variable, may alternatively be downloaded from or selected by the service provider 116. If variable, the downloading or selecting could occur periodically during playback, and the period may be calculated by the service provider 116 based on the input of the sensor 160. Alternatively, the period may be determinable by the microprocessor 200 from a parameter embedded in the video frames.

Freeing memory during playback, besides affording more recording opportunities to the user, provides the basis for a view-only-once content. As described above, the space a frame occupies is authorized to be overwritten or reused a latency time period after the frame has been played. This paradigm can be generalized to a service that allows the user to view a video for a specific number of times greater than one time. That is, the viewer 156 is given a particular number of times to view a frame of the video 330 before the availability of the frame's memory space to be overwritten or reused is made effective. The video player 204 in such an implementation is configured to refrain from marking a frame if the count of the number of times the frame has previously played is smaller than a predetermined threshold number.

In the above, limited-number-of-view content delivery model, as an alternative to merely making memory available for reuse or to be rewritten, a service provider may require that any frame viewed a number of times equal or greater to the predetermined threshold be deleted so as to be substantially unrecoverable. Placing a pointer to a memory space on the directory of available memory 222 makes the space available for reallocation to another requesting user of memory space. Even overwriting the frame previous occupying the space, however, does not guarantee the frame is unrecoverable. It is known, for instance, that reformatting a hard disk does not necessarily prevent determination of the content of the disk upon examination and analysis. Nevertheless, techniques exist, such as scrambling bits or rewriting all bits as zero bits, that make the former content of memory substantially unrecoverable.

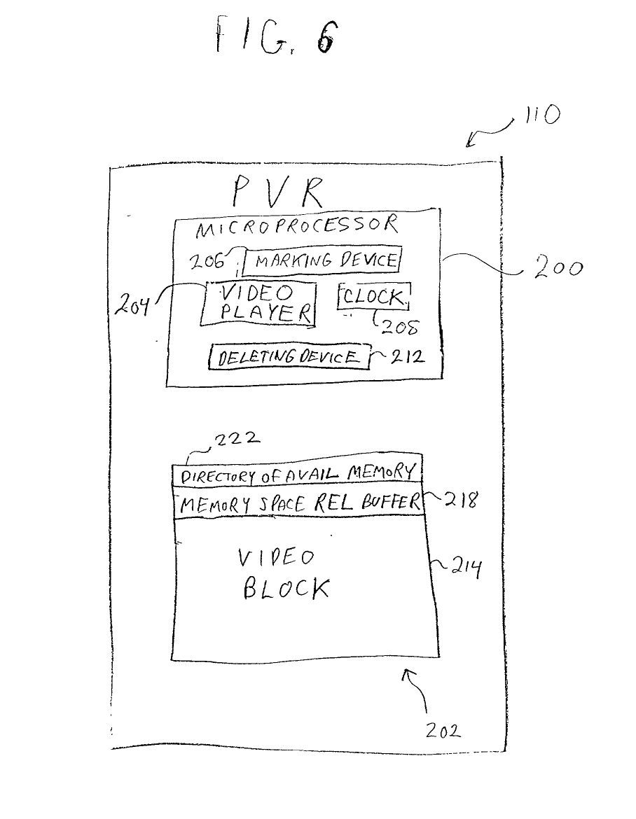

FIG. 6 shows a third embodiment of the invention directed to making the content of memory occupied by video frame that has played substantially unrecoverable, starting at a latency time period after playing. FIG. 6 is identical to FIG. 2, except that a deleting device 212 of FIG. 6 has been substituted for the releasing device 210 of FIG. 2. The process shown in FIG. 4A applies not only to the previous embodiments, but to the third embodiment as well. For the third embodiment, FIG. 4B is modified to substitute, for the step 418 of creating an entry, the step of scrambling, zeroing out, or otherwise overwriting the memory occupied by the marked frame. The service provider 116 can thereby prevent unauthorized recovery of the content.

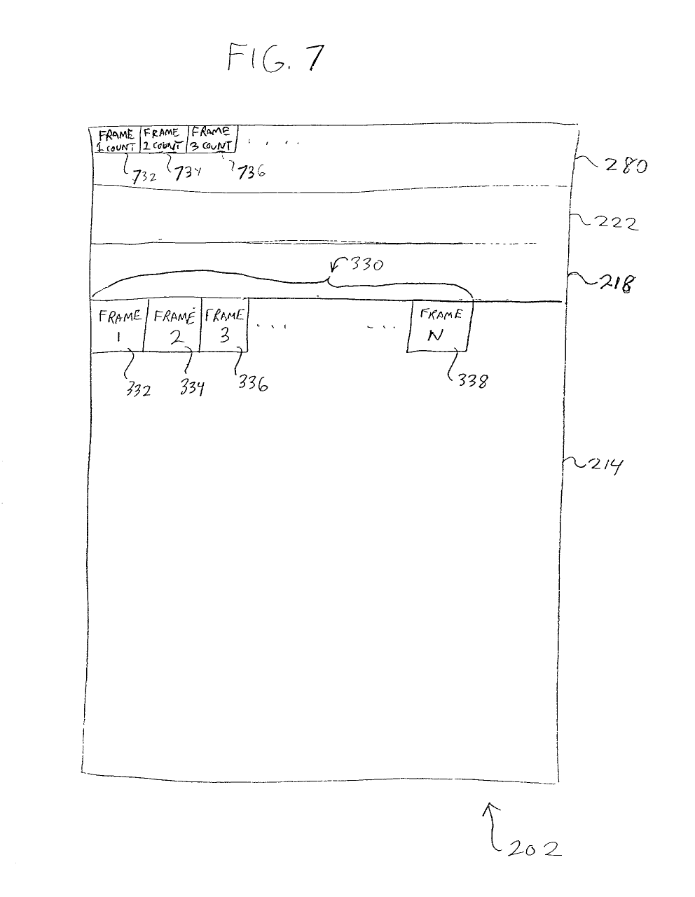

FIG. 7 illustrates in a fourth embodiment which can be implemented to supplement any of the first three embodiments of the invention, in which a viewer is afforded a specific number of viewings of a video. FIG. 7 shows the same digital memory as does FIG. 3, except that it includes an extra buffer, a frame count buffer 280. The buffer 280 has entries 732, 734 and 736, labeled count 1, count 2 and count 3, respectively, as well as other entries indicated by the dots. In this embodiment, the frames 332, 334, 336 and 338 of the video 330 are numbered as frames 1, 2, 3 to N respectively. The dots indicate intervening frames having intervening numbers. Frame 1 count, frame 2 count and frame 3 count of the buffer 280 entries 732, 734 and 736 are frame counts of the number of times frames 1, 2 and 3, respectively, have been previously played. That is, if frame 1 has previously played 0 times, frame 1 count, entry 732 is generated or entry 732 is changed from an inactive (“0”) state to an active (“1”) state that indicates a count of 1. Similarly, if frame 2 has previously played 1 time, entry 734 is updated from a count of 1 to a count of 2, etc.; i.e., the video player 204 generates or updates these frame counts as the video 330 is playing. The buffer 280 preferably is permanent storage that retains the counts when power to the playback system 100 is turned off. Although frame count buffer entries are shown for a single video 330, the frame count buffer 280 may retain counts for a number of videos.

In operation, each time a frame is played, its count is checked by the video player 204, and the frame is marked for deletion only if the count is equal to or greater than a predetermined threshold. The service provider is therefore able to select an upper limit to the number of times a video is played. The comparison of the count to the threshold is an extra check in the marking process and represents a step after step 402 in FIG. 4A. Ordinarily, update of the count occurs only in response to playing the frame in the forward direction, so that replay of a video segment does not count twice against the user. It is noted that although each frame has a respective count, counting can be performed at various levels; thus, a corresponding count could instead by assigned to each group of frames, and/or to each sequence of frames, etc. In any event, as in the previous embodiments, when the frame is marked for deletion, the deletion is authorized for any time starting a predetermined latency time period after the frame replay that triggered the marking.

In any of the above embodiments, if playback of the video 330 stops, and then resumes at a time when all viewed frames have been deleted, the remaining frames may need updating. Assume, for example, frames 1 through k have played at the time playback stops, so that only frames k+1 through n remain to be viewed in the video 330. Playback resumes at a time when the latency time period for each of frames 1 through k has expired. Assume further that frames k+1 and k+2 cannot be interpreted by the video player 204 without reference to content of one or more of the previous frames, i.e., frames 1 through k. Without the reference frame(s), the content of frames k+1 and k+2 cannot be faithfully displayed on the screen 124 when playback resumes. The present invention prevents this improper playback, by updating the initial frames that will be viewed upon resumption of playback, i.e., by making a “proper cut.”

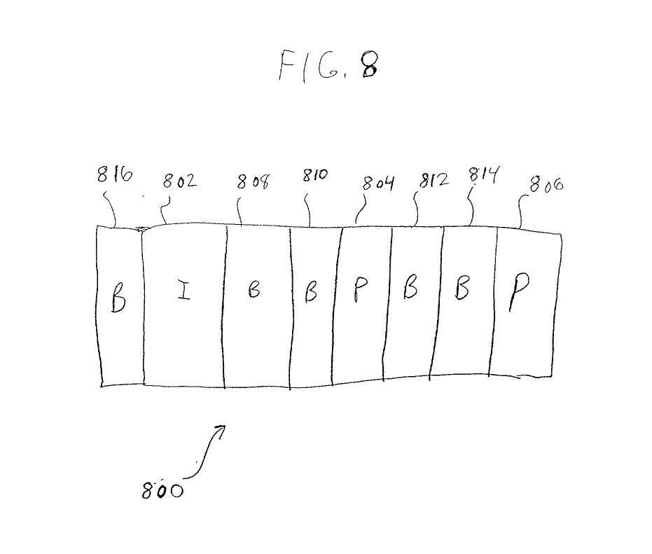

To illustrate this technique as applied to the MPEG-2 moving picture compression standard, FIG. 8 shows a hypothetical Group of Pictures (GOP) 800. The GOP 800 consists of a series of consecutive image frames in the video 330: intraframe coded frame 802, predicted frames 804 and 806, and bidirectional frames 808 through 816. Under MPEG, an intraframe coded frame represents a snapshot of a moving image. A predicted frame is based on the previous intraframe coded frame or predicted frame, and represents the differences between the moving image at the predicted frame's point in the image video over that of the previous reference frame, i.e., predicted frame or intraframe coded frame. For example, the predicted frame 804 uses the intraframe coded frame 802 as a reference. Since a bidirectional frame is based on both the previous intraframe coded or predicted frame and the next intraframe coded or predicted frame, the bidirectional frame 812 uses two predicted frames, 804 and 806, as references. Predicted and bidirectional frames are referred to herein as “interframe coded frames” and include motion compensation data to succinctly define movements of portions of the image as they progress in the image stream. The interframe coded frames, because they retain merely the difference data, are configured for compression to a size smaller than the intraframe coded frames, thereby reducing temporal redundancy. This reduction accounts for much of the advantage of compressing moving pictures with MPEG-2.

If playback stops and then resumes at a time when the latency time period has expired and viewed frames have been overwritten or their memory space has been reused, making the viewed frames no longer available, the frame at which the playback stopped may not be provide sufficient information from which to resume the video playback. That is, the frame at which playback stopped may be an interframe coded frame that is based on a previous reference frame that has now, at the time of playback resumption, been deleted. Consequently, the interframe coded frame is merely a “difference” image, without any reference, and its display results in any incomplete or noisy image.

To avoid an incomplete or improper display, the video player 204 defers to the previous intraframe coded frame when playback is halted, so that, upon the halting of playback, marking for deletion is withdrawn for all the viewed frames back to and including the previous intraframe coded frame.

For example, assume that playback stops during the viewing of frame 810, a bi-directional, and thus an interframe coded, frame. Marking of a frame may occur just prior, just after, or during playback of the frame. At the time playback of frame 810 stops, memory space for frame 810 may, depending upon the implementation, have been marked as available for overwriting or reuse, or, alternatively may not yet have been marked since playback of the frame 810 has not completed. In any event, by now, B frame 808 and I frame 802 have been marked. Assume further, that playback resumes at a time when the latency time periods for frames 802 and 808 have expired, and therefore the memory space for these frames has been made available for overwriting or reuse. Frame 810, as a B frame, requires information from the previous reference frame, here I frame 802, in order to be displayed correctly; yet, frame 802 may no longer exist in video block 214 because, for example, it has been overwritten.

The present invention circumvents this problem when the playback stops on an interframe coded frames by deferring to the last previous intraframe coded frame. In the present example, in which playback has stopped at frame 810, marking of frame 810 is suspended, or withdrawn if it has already occurred, and marking of frames 808 and 802 is withdrawn. Therefore, frames prior to frame 810 are available to allow playback to resume from its stopping point, at frame 810, with faithful display of frame 810. That is, in FIG. 8, if the video frame sequence shown in GOP 800 were stopped at frame 810, although frames 802 and 808 have been marked for deletion since they have been played, this marking, and any marking of frame 810, would be withdrawn so that playing of the remainder of the video, i.e., frame 810 and frames to the right of frame 810, could be properly accomplished.

The number of consecutive interframe coded frames in a video is not fixed under the MPEG-2 standard, but is left to the discretion of the user or implementer of the system. Ordinarily, the number of frames for which the deletion marking is withdrawn would not be large enough, in relation to the length of the latency time period, that any of the interframe coded frames following the last intraframe coded frame would already have been deleted at the time it is determined that marking for those of the frames marked is to be withdrawn. Therefore, when playback resumes, it resumes starting with an intraframe coded frame, with all the following interframe coded frames intact in the sequence. Accordingly, the video 330 is faithfully played back when playback of a halted video resumes.

As an alternative to deferring to the latest prior intraframe coded frame, deference is made to all frames that precede the current intraframe coded frame by no more than a predetermined number of frames. Therefore, for purposes of illustration, if frame 810 is playing when playback stops, and the predetermined number is two, marking is suspended for current frame 810 if its marking has not already occurred or withdrawn if it has occurred, and marking is withdrawn for frames 808 and 802, which precede the current frame 810 by no more than two frames. However, marking is not withdrawn for frame 816, because frame 816 precedes the current frame 810 by three frames, which is more than two frames. The predetermined threshold limits the amount of memory that is reserved and therefore unavailable for recording opportunities that may arise before playback resumes.

As a further alternative to deferring to the latest prior intraframe coded frame, the interframe coded frame at which playback halts can be updated based on previous reference frames and reconstituted as an intraframe coded frame. In this event, following interframe coded frames that depend on a reference that has been deleted would be similarly reconstituted as interframe coded frames or merely updated to refer to a previous reference frame that has not been deleted. Playback, as a result, resumes properly at the exact halting point in the frame sequence.

Although the illustrative embodiments of the present invention have been described herein with reference to the accompanying drawings, it is to be understood that the invention is not limited to those precise embodiments, and that various other changes and modifications may be effected therein by one having ordinary skill in the art without departing from the scope or spirit of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An apparatus for managing digital memory space occupied by a video frame comprising:
a marking device for marking said memory space for availability as memory space that can be overwritten or reused, said availability becoming effective after said video frame has played on a video player; and
means for overwriting or reusing said memory space.

2. The apparatus of claim 1, wherein said frame is part of a video in a digital memory that includes said digital memory space, said availability becoming effective during playback of said video.

3. The apparatus of claim 1, wherein said availability becomes effective at a predetermined latency time period after said playing of said frame.

4. The apparatus of claim 3, wherein said frame is part of a video in a digital memory that includes said digital memory space, said availability becoming effective during playback of said video.

5. The apparatus of claim 3, said apparatus further comprising a sensor for sensing if a viewer is actually watching a screen to which said frame is output as an image, said apparatus being further configured for adaptively calculating said latency time period based on an output of said sensor.

6. The apparatus of claim 1, said marking device being configured to refrain from said marking if a count of a number of times said frame has previously been played is smaller than a predetermined threshold.

7. The apparatus of claim 1, wherein said means for overwriting or reusing includes a memory space release buffer, and wherein said marking comprises saving to said buffer an identifier of said space.

8. The apparatus of claim 7, wherein said marking further comprises saving to said buffer a time stamp corresponding to said playing of said video frame.

9. The apparatus of claim 8, wherein said time stamp represents a predetermined latency time period after said playing of said frame, and wherein said means for overwriting or reusing further includes a releasing device that is configured to periodically compare said time stamp to a current reference time and, at a time based on said comparison, to update a directory of available memory to reference said space.

10. The apparatus of claim 1, wherein said digital memory space is occupied by a video that includes said video frame, said video including another video frame in said digital memory space that precedes said video frame by no more than a predetermined number of frames in said memory space, wherein if playback stops at said frame, marking of the another frame is withdrawn.

11. The apparatus of claim 1, wherein said digital memory space is occupied by a video that includes said video frame, said video including another video frame in said digital memory space that precedes said video frame, said frame being interframe coded and said another frame being a reference frame, wherein, if playback stops at said interframe coded frame, marking of the reference frame is withdrawn.

12. An apparatus for managing digital memory space occupied by a video frame comprising:
a marking device for marking said memory space for availability as memory space that can be overwritten, said availability becoming effective after said video frame has played on a video player; and
a deleting device for writing into said memory space after said frame has played on said video player to make said video frame substantially unrecoverable.

13. A method for managing digital memory space occupied by a video frame comprising the steps of:
playing said video frame; and
marking said memory space for availability as memory space that can be overwritten or reused, said availability becoming effective after said playing step.

14. The method of claim 13, wherein said frame is part of a video in a digital memory that includes said digital memory space, said availability becoming effective during playback of said video.

15. The method of claim 13, wherein said availability becomes effective at a predetermined latency time period after said playing of said frame.

16. The method of claim 15, wherein said frame is part of a video in a digital memory that includes said digital memory space, said availability becoming effective during playback of said video.

17. The method of claim 15, said method further comprising the steps of:
outputting said frame as an image on a viewing screen;
sensing if a viewer is actually watching said screen; and
adaptively calculating said latency period based on an output of said sensor.

18. The method of claim 13, wherein said marking step is foregone if a count of a number of times said frame has previously been played is smaller than a predetermined threshold.

19. The method of claim 13, wherein said marking step comprises saving to a memory space release buffer an identifier of said space and a time stamp corresponding to said playing of said video frame.

20. The method of claim 19, wherein said time stamp represents a predetermined latency time period after said playing of said frame, said method further comprising the steps of:
periodically comparing said time stamp to a current reference time; and
at a time based on said comparison, updating a directory of available memory to reference said space.

21. The method of claim 13, wherein said digital memory space is occupied by a video that includes said video frame as a current frame, said video including another video frame in said digital memory space that precedes said video frame by no more than a predetermined number of frames in said memory space, said method further comprising the steps of:
playing said another video frame;
marking said another video frame; and
withdrawing the marking of said another frame if playback stops at said current frame.

22. The method of claim 13, wherein said digital memory space is occupied by a video that includes said video frame, said video including another video frame in said digital memory space that precedes said video frame, said frame being interframe coded and said another frame being a reference frame, said method further comprising the steps of:
playing said reference frame;
marking said reference frame; and
withdrawing the marking of said reference frame if playback stops at said interframe coded frame.

23. The method of claim 13, wherein said availability is as memory space that can be overwritten, said method further comprising, after said playing step, the step of writing into said memory space to make said video frame substantially unrecoverable.

24. A method for maintaining storage in a digital memory during playback on a video player, comprising:
playing a video frame that resides in an area of digital memory; and
marking said frame to be deleted after said playing.
